(19) United States
(12) Patent Application Publication
(10) Pub. No.: US 2015/0283847 A1
(43) Pub. Date: Oct. 8, 2015

(54) Information Medium And A Method Of Producing The Same

(71) Applicants: Pooi Nguon LIM, (US); Siew Lian LOO, (US); Guen Ai SIA, (US)

(72) Inventors: Pooi Nguon Lim, Pulau Pinang (MY); Siew Lian Loo, Kuala Lumpur W.P. Kuala Lumpur (MY); Guen Ai Sia, Kuala Lumpur W.P. Kuala Lumpur (MY)

(21) Appl. No.: 14/646,381

(22) PCT Filed: Nov. 21, 2013
(86) PCT No.: PCT/MY2013/000222

§ 371 Date: May 20, 2015

(30) Foreign Application Priority Data
Nov. 21, 2012 (MY) PI 2012700979

(51) Int. Cl. B42D 25/351; B32B 3/26; B42D 25/40

(52) U.S. Cl. CPC B42D 25/351; B42D 25/40; B32B 3/266; B32B 2307/41; B32B 2307/412; B32B 2307/414; B32B 2425/00; B32B 2429/00; B32B 2519/00

(57) ABSTRACT

The invention provides for an information medium containing one or more light transmissible opening. Further processes and/or security features may be added within this see-through section or on other part(s) of the information medium body or both. This includes, but not limited to, personalization, hologram stamping, laser engraving, printing, etc.

### FIELD OF INVENTION

The present invention relates to information medium for a secured digital travel document. More particularly, the present invention relates to an information medium having a see-through window, and a method of producing the same.

### BACKGROUND

Any personalization or other features done in the light transmissible opening allows it to be viewed from both sides of the information medium. The light transmissible opening can be at least used as a level 1 security feature where authentication can be done visually, i.e. under naked eyes, without any aide or equipment. Therefore it is desired that to provide a system and method of producing an information medium with a see-through window.

### SUMMARY

In one aspect of the present invention, there is provided an information medium comprises a core layer defining an opening; and two transparent layers adapted to sandwich the core layer there between. The opening provides a see-through window defining the information medium.

In one embodiment, the core layer may comprise a first opaque layer defining the opening. It is possible that the core layer comprises a second opaque layer defining a second opening with at least a portion of the second opening align with the opening to define the see-through window. It is also possible that the opening is different in size and/or shape from the second opening. An intermediate transparent/translucent layer may also be provided between the first opaque layer and the second opaque layer.

In another embodiment of the present invention, the core layer comprises a first printed layer with an unprinted area defining the opening. The core layer further comprises a second printed layer with a second unprinted area defining a second opening. At least a portion of the second opening aligns with the opening to define the see-through window.

In another aspect of the present invention, a method of forming an information medium can also be provided.

### BRIEF DESCRIPTION OF DRAWINGS

FIG. 1 is an exploded cross-sectional drawing of an information medium with a light transmissible opening according to a first embodiment of the present invention;

FIGS. 2A and 2B are exploded cross-sectional drawings of two embodiments of information medium of the present invention;

FIGS. 3A and 3B are exploded cross-sectional drawings of two further embodiments of information medium of the present invention;

FIGS. 4A, 4B and 4C are exploded cross-sectional drawings of another three embodiments of the information medium of the present invention;

FIGS. 5A and 5B are exploded cross-sectional drawings of further two alternative embodiment of the information medium of the present invention.

### DETAILED DESCRIPTION

Embodiments of the present invention shall now be described in detail, with reference to the attached drawings. It is to be understood that no limitation of the scope of the invention is thereby intended, such alterations and further modifications in the illustrated device, and such further applications of the principles of the invention as illustrated therein being contemplated as would normally occur to one skilled in the art to which the invention relates.

The present invention illustrates various embodiments of an information medium with a light transmissible opening and method of producing the same. The information medium includes, but not limited to, security and/or non-security documents or papers such as identity cards, passports, e-passports, visa, e-visa, driving licenses, health card, badges, banking cards, loyalty cards, etc. The information medium may or may not include one or more chip and/or module and/or integrated circuit. The information medium may be made of any kind of polymer or composite of polymers, including but not limited to polycarbonate (PC), polyvinylchloride (PVC), polyethylene (PET), polyurethane (PU) or any other suitable materials.

Adapting one or more light transmissible openings on an information medium would make it difficult to forge and copy/scan optically (i.e. under photocopier or scanner) or duplicate as such light transmissible openings allows a 3D security feature to be implemented thereon by connecting the front and the back side of the information medium. It is also desired that the light transmissible opening shall also temper-proof. Any tempering attempt will be obvious as it may cause the opening becoming opaque or have increased opacity.

Security features may be added in or around the light transmissible opening or on the entire information medium to further reinforce the security of the information medium.

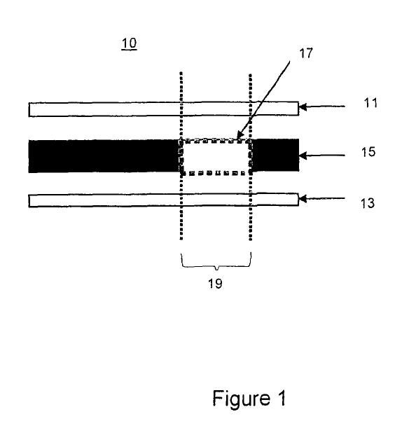

FIG. 1 illustrates a explored cross-sectional view of a information medium 10 having a light transmissible opening according to a first embodiment of the present invention. The information medium 10 comprises an opaque layer 15 defining an opening 17 and two transparent layers 11 and 13. The opaque layer 15 is adapted to sandwich between the two transparent layers 11 and 13. The opaque layer 15 and the two transparent layers 11 and 13 can be laminated together under high heat and/or compressions. The two transparent layers 11 and 13 overlay on top and bottom of the opaque layer 15 and covering the opening on both sides. The laminated piece forms the information medium having a see-through window 19.

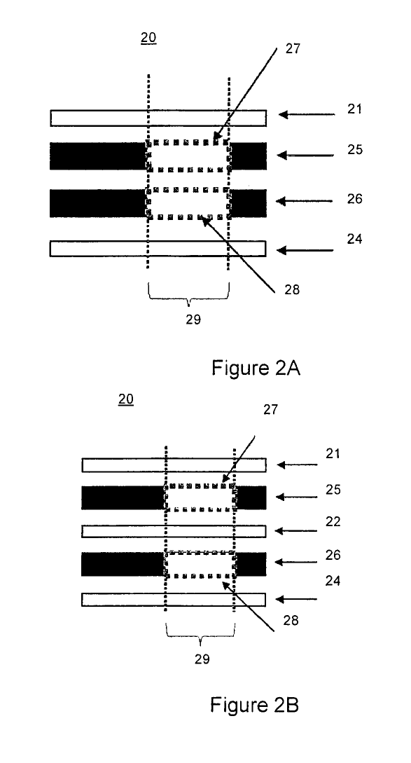

FIGS. 2A and 2B illustrate two alternative embodiments of the information medium 20 of the present invention. As shown in FIG. 2A, the information medium 20 comprises two opaque layers 25 and 26 and two transparent layers 21 and 24. Both opaque layers 25 and 26 have respective openings 27 and 28 of the same size and location defined thereon. The two opaque layers 25 and 26 are placed together with the openings 27 and 28 aligned to form a light transmissible opening. The opaque layers 25 and 26 are then being sandwiched between the two transparent layers 21 and 24 to form the information medium 20 with a see-through window 29.

In one embodiment, the two opaque layers 25 and 26 can be bonded together via suitable chemical means, such as adhesive. In another embodiment, the two opaque layers 25 and 26 can be secured together via the laminations between the two transparent layers 21 and 24. In yet another embodiment, the two opaque layers 25 and 26 can be attached together via high temperature and/or compressions.

One or more transparent layers 22 may be added between the two opaque layers 26 as shown in FIG. 2B.

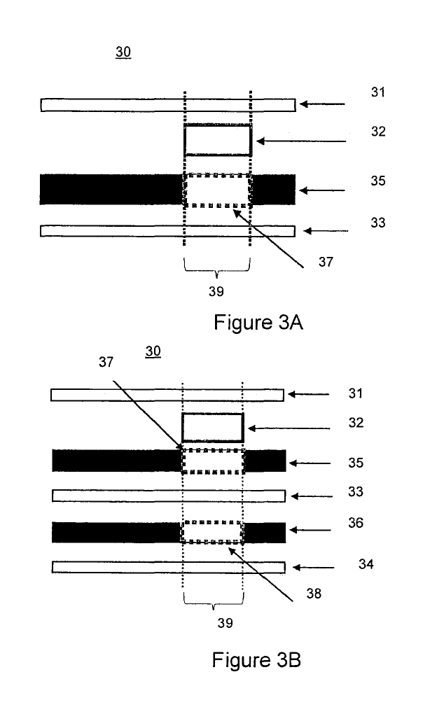

FIG. 3A illustrates an information medium 30 having a see through window 39 in accordance with yet another embodiment of the present invention. The information medium 30 comprises an opaque layer 35 defining an opening 37, filler 32 and two transparent layers 31 and 33. The filler 32 is a transparent/translucent material provided to fill in the opening 37. It can be a cut off material to fit in to the opening 37, or alternatively a fluid or semi-solid material provided to fill in the opening 37. The opaque layer 35 is sandwiched between the two transparent layers 31 and 33 after the opening 37 is filled up. The opaque layer 35 and the two transparent layers 31 and 33 can be laminated together under high heat and/or compressions. The two transparent layers 31 and 33 overlay on top and bottom of the opaque layer 35 and cover the opening 37 on both sides. The laminated piece forms the information medium 30 having the see-through window 39.

FIG. 3B illustrates another embodiment of the information medium 30 of the present invention. The information medium 30 has an essentially the same configurations as that shown in FIG. 3A, with an opaque layer 36 and a transparent layer 34 added below in a similar manner. The opaque layer 36 also defines an opening 38 that has a same size and corresponding position as the opaque layer 35. In this embodiment, the opening 38 on the opaque layer 36 may or may not be filled with the transparent/translucent material.

The filler may be attached with adhesives or may be heat-activated.

Accordingly to the present invention, the filler may be in any form, such as solid and semi-solid form. The filler may further comprise adhesive as bonding agent to bond the filler onto the opaque layer. The adhesive can also be any bonding agent, inclusive heat-activated bonding agent. Similarly, the present invention is not limited to embodiments of the information medium that has one or two layers.

It is possible that the information medium may further comprise single opaque or multiple opaque layers that have openings defined thereon. The information medium may also comprise one or more transparent layers inserted between the opaque layers as intermediate layer. It is also possible that the information medium comprises opaque and transparent layers in any combinations.

In yet a further embodiment, the transparent layer may also defines corresponding opening, when desired. In the event that the intermediate transparent layer does not consist of an opening or aligned openings with the opening(s) in the opaque layers, one or more filler material may be introduced from any side opaque layers. The information medium may be a laminated article one or more outer transparent layer(s) as protective layers.

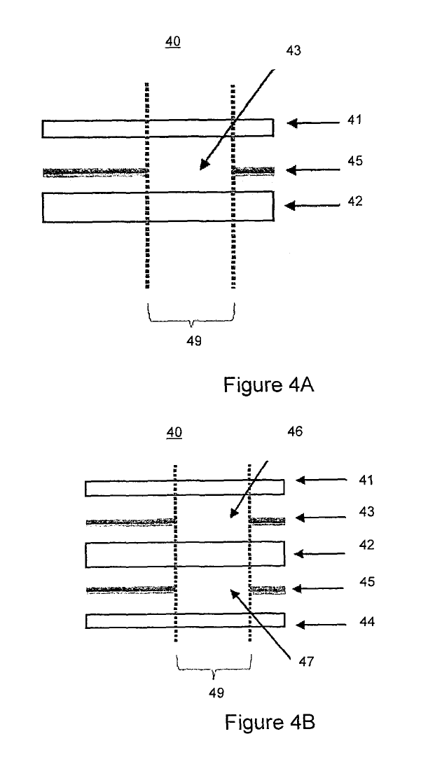

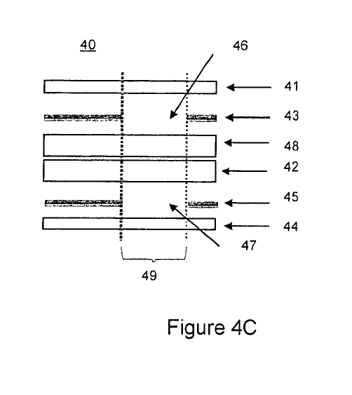

FIG. 4A illustrates an information medium 40 in accordance with yet another embodiment of the present invention. The information medium 40 comprises two transparent layers 41 and 42 that are laminated together with a printed layer 45 disposed there between. The information medium 40 is formed by printing the printed layer 45 on one transparent layer 42 leaving an area 43 unprinted to define the opening area or light transmissible opening. The printed layer 45 can be printed with any suitable ink through any suitable printing methods. Once the printed layer 45 is formed as desired, another transparent layer 41 is laminated on top of the printed layer 45 to conceal it there between. The artwork of the printed layer 45 can be viewed from both sides of the information media card with one see-through window 49 defining thereon.

FIG. 4B illustrates the information medium 40 accordance with an alternative embodiment of the present invention. In this embodiment, there is provided a core transparent layer 42 with both sides printed with a first printed layer 43 and a second printed layer 45 respectively. With this embodiment, it is possible to provide different artworks independently on both sides. Similarly, the first printed layer 43 and the second printed layer 45 are printed with unprinted layers 45 and 47 defining a see-through window 49. Once the printed layers 43 and 45 are provided, two transparent layers 41 and 44 can be provided to sandwich the core transparent layer 42 in between to conceal the two printed layers 43 and 45.

In an alternative embodiment, it is also possible to pre-printed the printed layer 43 and the printed layer 45 on the transparent layer 41 and transparent layer 44 respectively, and then laminates the core transparent layer between the two printed transparent layers 41 and 44 to form the information medium.

Depending on the ink used for printing the printed layers, a layer of base ink may be required to allow proper adhesion of the ink on the transparent layer. When desired, it is also possible to provide multiple printed layers printed on each side of the transparent layers.

FIG. 4C illustrates an information medium in accordance with a further embodiment of the present invention. In this embodiment, there is provided two core transparent layers 42 and 48 for sandwiching between the two transparent layers 41 and 44. Before the two transparent layers 42 and 48 are sandwiched, it may be pre-printed with printed layers 45 ad 43 respectively. Once the printed layers 45 and 45 are formed, the two transparent layers 41 and 44 can be provided to laminate the two core transparent layers 42 and 48 together with the printed layers 43 and 45 to form the information medium.

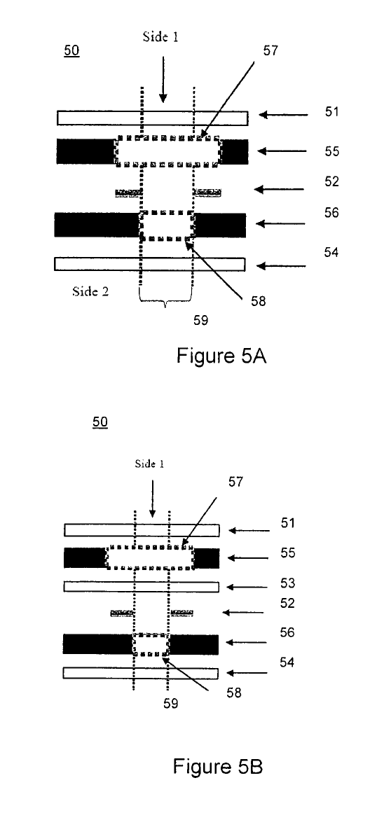

FIG. 5A illustrates an information medium 50 in accordance with a further embodiment of the present invention. The information medium 50 comprises a first opaque layer 55, a second opaque layer 56, an security layer 52 and two transparent layers 51 and 54. The first and second opaque layer 55 and 56 define a first opening 57 and a second opening 58 respectively. The first opening 57 and the second opening 58 may be provided with different sizes and/or shapes, with at least a portion of the openings 57 and 58 aligned provide a see-through window 59. In this case, the first opening 57 is larger than the second opening 58. The two opaque layers 55 and 56 may be laminated together between the first transparent layer 51 and the second transparent layer 54 to form the information medium with the see-through window 59.

In another embodiment, if desire, there may be provided with a security layer 52 that contains security features at the see-through window 59 for allowing visual verification through the see-through window 59. The security layer 52 may be a printed layer provided around the perimeter of the second opining 58 so that it is visible through the first opining 57 on side 1.

In a further embodiment as illustrated on FIG. 5B, the information medium 50 may include one or more transparent layers 53 between the opaque layers 55 and 56. In this case, the security layer 52 may be provided on the transparent layer 53.

As illustrated in FIG. 5A and 5B, the inner side of the opaque layer 56 with the smaller opening 58 can be seen from the side of the opaque layer 55 with the larger opening 57 on side 1. The security feature may be provided in any of the opaque and/or transparent layer(s) so that it is visible from Side 1 only and not Side 2 or visible from Side 1 without any aide and visible from side 2 with the aide of a bright light or any other kind of lighting. The security feature(s) may include but not limited to laser engraving, printing, etc. The security feature(s) may be applied on the whole card or at the specific area where the inner side of the opaque core can be seen or in the light transmissible opening or any combination of the above.

It is understood to a skilled person that there can be many types of configuration for forming a see-through window on an information medium. With that in mind, when two opaque layers or two printed layers are used, it is possible to form a first opening different from a second opinion in size and shape without any limitation as long as at least a portion of both opening are aligned to facilitate a see-through window.

It is also understood to a skilled person that the openings on the opaque layers can be produced via a punching method consisting of a cutting tool and a machine that exerts pressure downwards to create the openings. One possible cutting tool may include of a wooden base and cutting blades which are embedded into the wooden base, herein referred as a woodknife.

The cutting blades are at an angle 90 degrees to the wooden base, with its sharp edges pointing upwards. The top part of the wooden base are covered with a soft to reasonably soft sponge or any other suitable material, exposing only the tip of the cutting blades.

The material or materials intended to be punched to create opening(s) are laid flat on the woodknife, with the woodknife's cutting blades below the said material to be punched. The woodknife and material in the said configuration is placed in a machine which exerts a downward pressure on the material and woodknife up to a certain depth. The sponge provides cushioning when the machine presses downwards on the material and the woodknife. The material(s) is pressed upon the cutting blades and thus are separated from the sheet, creating the opening(s).

The openings are produced before laminations. The information medium may be laminated with high temperature and pressure for a certain period in a hot chamber before being transferred to a cold chamber to be cooled with a certain lower temperature for a certain period. The information medium may or may not be exerted with pressure in the cold chamber. The lamination parameter may be a single step or multiple steps for either hot or cold chambers or both.

It is also understood to a skilled person that the transparent layer may also be a semi-transparent or translucent layer, when desired.

While specific embodiments have been described and illustrated, it is understood that many changes, modifications, variations, and combinations thereof could be made to the present invention without departing from the scope of the invention.

1. An information medium comprising:
a core layer defining an opening; and
two transparent layers adapted to sandwich the core layer there between;
wherein the opening provides a see-through window defining the information medium.

2. The information medium according to claim 1, wherein the core layer comprises a first opaque layer defining the opening.

3. The information medium according to claim 2, wherein the core layer comprises a second opaque layer defining a second opening with at least a portion of the second opening align with the opening to define the see-through window.

4. The information medium according to claim 3, wherein the opening is different in size and/or shape from the second opening.

5. The information medium according to claim 3, further comprising an intermediate transparent/translucent layer between the first opaque layer and the second opaque layer.

6. The information medium according to claim 1, wherein the core layer comprises a first printed layer with an unprinted area defining the opening.

7. The information medium according to claim 6, wherein the core layer further comprises a second printed layer with a second unprinted area defining a second opening, wherein at least a portion of the second opening aligns with the opening to define the see-through window.

8. A method of forming an information medium, the method comprising:
providing a core layer having an opening; and
sandwiching the core layer between two transparent layers,
wherein the opening provides a see-through window defining the information medium.

9. The method of claim 8, wherein the core the core layer comprises a first opaque layer defining the opening.

10. The method of claim 8, wherein the core layer comprises a second opaque layer defining a second opening with at least a portion of the second opening align with the opening to define the see-through window.

11. The method of claim 9, wherein the opening is different in size and/or shape from the second opening.

12. The method of claim 9, further comprising providing an intermediate transparent/translucent layer between the first opaque layer and the second opaque layer.

13. The method of claim 8, wherein the core layer comprises a first printed layer with an unprinted area defining the opening.

14. The information medium according to claim 13, wherein the core layer further comprises a second printed layer with a second unprinted area defining a second opening, wherein at least a portion of the second opening aligns with the opening to define the see-through window.
